(19) United States
(12) Patent Application Publication
(10) Pub. No.: US 2012/0050037 A1
(43) Pub. Date: Mar. 1, 2012

(54) CRITICAL PEAK PRICING AUDIO ALERT

(75) Inventors: Joseph Mark Brian, Louisville, KY (US); Michael Thomas Beyerle, Pewee Valley, KY (US); Jay Andrew Broniak, Louisville, KY (US); David C. Bingham, Louisville, KY (US)

(73) Assignee: General Electric Company

(21) Appl. No.: 12/873,951

(22) Filed: Sep. 1, 2010

(51) Int. Cl. G08B 21/00

(52) U.S. Cl. 340/540

(57) ABSTRACT

An energy management system and method of alerting a consumer of a peak pricing event receives information relating to cost of energy use and communicates data to one or more appliances in response thereto. An audible source operatively associated with a controller/module or one or more appliances signals a response. The audible signal can be used in conjunction with other types of alerts to the homeowner. The system preferably uses existing microprocessor based speakers provided in one or more appliances in order to disseminate the audio signal throughout the home.

### BACKGROUND OF THE DISCLOSURE

This disclosure generally relates to relates to energy management, and more particularly to energy management of household consumer appliances. More specifically, the disclosure relates to an alert or reminder system for a homeowner or consumer, and particularly to an audio alert associated with a pricing change implemented by a utility.

In existing energy management systems, day-to-day price changes are routine and generally happen at known intervals via a published schedule. Price fluctuations may only be in the 0-100% range across any given 24 hour period relative to a baseline price. During critical price events, the price may increase up to 500% or more from the baseline price, so the consumer/homeowner would like to be made aware of this event so that the opportunity to save energy costs and reduce energy use event is not inadvertently missed or overlooked. Failure to take action could result in higher utility bills and customer dissatisfaction. Consequently, improved reminders or alerts relating to implementation of the critical price event are desirable.

Various options of conveying the peak pricing event and peak pricing information have been proposed. For example, a message is typically displayed on a home service display. One exemplary embodiment delivers a text message in the early morning hours, e.g., between 3 a.m. and 7 a.m., well in advance of an anticipated afternoon peak price period (which is the time of day in which the vast majority of high or critical peak price periods are encountered). In some instances, the display then changes colors, for example the display turns to red when the peak price event is encountered, and other information may also be provided on the display such as the current price of the utility costs. As will be appreciated, the homeowner could miss the message regarding the peak price period or may be away from the home when the original message is displayed. One common messaging system displays the energy management data on a programmable thermostat. A consumer could miss the critical price event or message if the consumer fails to check the thermostat.

On the other hand, a careful balance must be struck between alerting the consumer and any reminder system becoming an annoyance. Thus, it is presumed that the consumer/homeowner will normally receive the message from the utility in the conventional way. However, an alternative mode of alerting the homeowner is desired.

It is also generally conventional to provide a single location where the message is delivered to the consumer. That is, the display associated with a home energy manager may be at a central location in the home, e.g., programmable thermostat, home computer, separate display associated with home energy module, etc. Either a display or a visual alert (one or more lights) is provided to the consumer to apprise the homeowner of an upcoming peak price event. There are times, of course, when the homeowner is not situated in that location in the home and yet would still like to be informed of an upcoming peak pricing event, particularly if no prior action has been taken by the homeowner.

It will also be appreciated that such an improvement should not add significant cost to the system. Thus, there is a desire to use existing hardware associated with the system and/or appliances to provide for this additional reminder or alert. Most preferably the modification or implementation of the additional alert would be one that could be effected via a software change as opposed to modifying or providing additional hardware to provide a supplemental alert in addition to the previously supplied manner of alerting the consumer, e.g. e-mails, instant messages, cell phone texting, streaming information to video displays, etc.

### SUMMARY OF THE DISCLOSURE

A demand supply or energy management system includes a controller adapted to receive information relating to cost of energy use and communicate data to an associated appliance in response thereto. An audible source is operatively associated with at least one of the controller and an associated appliance for emitting an audible signal in response to an energy use cost event.

In an exemplary embodiment, the audible source is emitted from any appliance with a microcontroller and speaker.

The energy management system preferably emits an audible system from more than one location.

The audible source may be a series of buzzes or beeps.

Preferably, the audible source is emitted in advance of a peak pricing event.

A method of alerting a consumer or homeowner of a peak pricing event includes receiving information relating to a cost of energy use, communicating data to a home energy management system regarding the cost of energy, and providing an audible alert in response to the cost of energy reaching a predetermined threshold.

In one exemplary embodiment, the audible source is included in at least one home appliance. The audible source may be alternatively or additionally included in a home energy manager. or controller.

A user interface is operatively associated with the controller to allow a homeowner to enable or disable the audible alert.

The audible alert may be used in conjunction with one or more other alerts, including, for example, a text message or visual alert.

A primary benefit is improving the prospects for a consumer/homeowner being informed that a critical peak price event is about to occur by providing an additional communication path to the consumer that will alert the consumer to the impending price change.

Another benefit is associated with the ability to incorporate this feature without additional hardware.

Still another advantage resides in the low cost modification to the software.

Still other features and benefits of the present disclosure will become apparent from reading and understanding the following detailed description.

### BRIEF DESCRIPTION OF THE DRAWINGS

FIG. 1 is a schematic representation of an energy management system that receives and communicates data relating to an energy pricing event to various home appliances.

FIG. 2 is a portion of a video display.

### DETAILED DESCRIPTION OF THE PREFERRED EMBODIMENTS

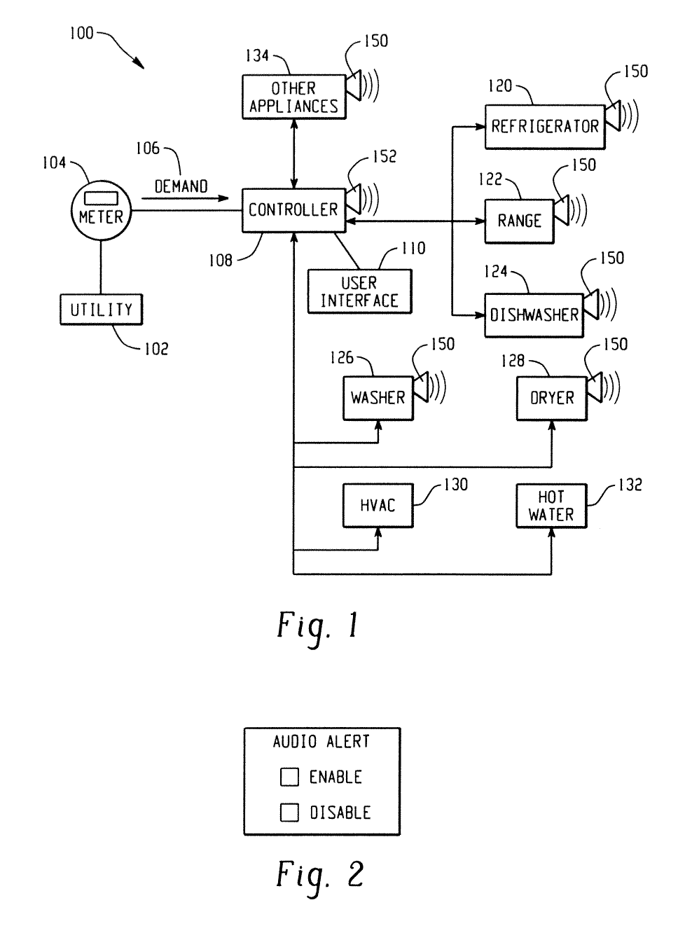

Turning to FIG. 1, there is shown a demand supply or an energy management system such as energy management system 100 in which a utility or energy supplier 102 communicates with a consumer/homeowner via an interconnection with a meter 104, for example. The connections between the utility and the meter may be wired, or wireless, and in turn provides data or information broadly referenced as demand 106 that is provided to controller 108. The controller 108 may be a module or a part of a module that is adapted to receive the information relating to the cost of energy use (the demand signal 106) and, in turn, communicates this data to one or more appliances in the home. The controller 108 may adopt a wide variety of configurations and typically has a user interface 110 such as a keyboard, touch screen, etc. that allows the homeowner to not only input information but also to view information relating to energy use, energy cost, peak pricing events, etc.

The controller 108 is in communication with the various appliances in the home. Specific appliances are identified for purposes of the following discussion such as a refrigerator 120, range 122, dishwasher 124, clothes washer 126, clothes dryer 128, heating, ventilation, air conditioning (HVAC) 130, and hot water heater 132. This list of appliances is not deemed to be exhaustive but rather exemplary and still other appliances are generically represented by reference numeral 134. Among this group of other appliances 134 may be specific appliances that receive data from the controller 108 and in turn communicate with the controller so that if there is a pricing change, operation of one or more of the appliances may be electively altered by the homeowner. For example, four different energy pricing levels are commonly used to represent levels of energy use or demand and that may correspond to different levels of energy pricing. For example, “LOW”, “MEDIUM”, “HIGH”, and “CRITICAL” are four representative levels, although one skilled in the art will understand that different nomenclature and a greater or lesser number of levels may be used without departing from the scope and intent of the present disclosure.

The homeowner may elect to alter “normal” operation of one or more appliances in response to a peak pricing event, for example, a HIGH or CRITICAL alert level. In these instances, the cost of using energy may significantly increase so that the homeowner may desire to undertake alternative operation of one or more appliances in an effort to reduce energy use and also save money. Many of the various appliances 120, 122, 124, 126, 128 in the home are oftentimes already equipped with a microprocessor and speaker as represented by reference numeral 150. Not all appliances have such capability as represented by the HVAC 130 or hot water heater 132, although many appliances already incorporate a microprocessor-controlled speaker as a feature. One skilled in the art will also understood that the existing capability of the appliance to emit a sound may be a simple sound such as a “beep”, “buzz”, “bell”, “chime” or the like, as is commonly associated with a refrigerator, microwave, range, dishwasher, etc. This existing, sound-emitting capability should not be construed as preventing the use of more complex sounds (variable volume, music, ring-tones, etc.), although more complex sounds may require a more sophisticated microprocessor, sound file, etc.

As will also be appreciated, various ones of these appliances are located in different locations in the home. The refrigerator, range, and dishwasher may all be located in a kitchen area, while the washer and dryer may be located in a utility room. HVAC and hot water heaters may be located in the basement, while still other appliances can be located in remote locations (garage door opener in the garage, pool pump in the backyard, attic fan in the attic, etc.). Although this latter group is not typically deemed to incorporate a microprocessor and associated speaker, the system may be set up so that all appliances capable of emitting an audible sound will do so in response to a signal from the controller. Thus, rather than just a video or text message being available at the user interface, an audible signal is now present at multiple locations throughout the house. Thus, the audio alert or audible signal is not exclusive relative to other alerts, i.e., can be used in conjunction with other notifications such as light, e-mail, video screen, text, etc.

Likewise, it is envisioned that the audible alert will be provided through the various appliances (whether operation of the appliance is selected by the homeowner to be altered in response to a peak pricing event or not) but the skilled artisan will appreciate that the concept can be expanded. For example, the controller may also include a speaker 152 and therefore can be a part of the array of speakers that provide an audible alert to the homeowner in response to a peak pricing event.

As noted above, since the sound emitting capabilities of various appliances are often relatively simple, the actual type of audible signal is not particularly pertinent. A series of intermittent beeps or other similar sound(s) can be provided just prior to the peak pricing event in order to alert the homeowner of the impending cost increase and potential energy savings that could be available to the homeowner.

In an exemplary embodiment, the user interface 110 preferably has an “enable/disable” feature (FIG. 2) for activating and deactivating the auxiliary audible signal on and off. For example, the homeowner can either “enable” or “disable” the audible signal feature at the user interface such as by selecting a check box provided on a menu of the video display that is selectively accessed via the 110 user interface by which the homeowner can either turn the audible alert on or off. It is contemplated that no further complexity than a simple enable or disable would likely be required, although the level of sophistication and complexity will be dictated by cost, consumer preference, and system capability.

Similarly, the audible signal is likely to be a series of beeps so that the homeowner is apprised that there is a signal and does not construe a single beep as an inadvertent audible signal that might otherwise be ignored or overlooked. The audible signal is either detected or not detected by the homeowner (i.e., there is no follow up signal or assertive action that needs to be taken by the homeowner to confirm receipt of the audible alert). It is unlikely that the volume would be altered—such as increasing in volume or frequency. Instead, it is preferred that the audible alert be a simple notification that is low cost and does not become an annoyance to the homeowner/consumer. Further, it will also be appreciated that by using the existing hardware associated with one or more appliances, the energy management system 100 can be easily altered via software associated with the controller to easily include the audible alert feature. That is, although it may be possible to equip a module or an appliance that does not otherwise have a sound emitting capability with such a feature, such cost is generally deemed undesirable. Rather, the use of existing hardware and the ability to use that hardware in a different manner by way of a simple software change that still provides a suitable audible alert is much more desired.

It is also contemplated that select appliances may have sound emitting capability and in fact may emit a sound if so enabled, but it is not necessary that one or all of these appliances undertake any alteration in their operation during the peak pricing event. As with many the demand response systems, the ability to modify operation of one or more appliances in response to a peak pricing event is typically left to the election of the consumer.

Any appliance in the home network that has knowledge of a critical peak price event and that is capable of receiving signals from a smart meter or other energy service interface could potentially be used to signal the alert. This system provides wider coverage in the home to ensure that the homeowner is notified. Since day-to-day price changes are routine and happen at known intervals via a published schedule, during critical price events, price may increase more dramatically than during other price events relative to the baseline price. It is these features in particular that a consumer may wish to enable the audible alert so that there is less chance of the consumer failing to take action in a timely fashion.

In summary, the disclosure works within the context of a microprocessor-based device such as a home energy manager or controller/module that receives signals from a smart meter or other energy services interface (ESI). The system need not only be an appliance, but any device that either directly, or indirectly receives the peak price event data from the ESI. This will include appliances, IHD (in-home display), and thermostats at a minimum. When indication of a peak price event is received from the ESI, an audio alert is sounded within the home to alert the homeowner that peak pricing is about to take effect. Any appliance in the home and tied into the home network that has knowledge of the peak pricing event could also potentially be used to signal the alert. This would provide wider coverage inside the home to ensure that the consumer/homeowner is notified.

The disclosure has been described with reference to the preferred embodiments. Obviously, modifications and alterations will occur to others upon reading and understanding the preceding detailed description. It is intended that the disclosure be construed as including all such modifications and alterations.

What is claimed is:

1. An energy management system comprising:
a controller is adapted to receive information relating to cost of energy use and communicate data to an associated appliance in response thereto; and
an audible source operatively associated with at least one of the controller and associated appliance for emitting an audible signal in response to an energy use cost event.

2. The energy management system of claim 1 wherein the audible source is integrated into a module that includes the controller that receives the information relating to the cost of energy use.

3. The energy management system of claim 1 wherein the audible source is operated intermittently in response to the energy use cost event.

4. The energy management system of claim 1 wherein the audible source is remotely located relative to a home appliance that potentially benefits from the energy use cost event.

5. The energy management system of claim 1 wherein the audible source is emitted in advance of the energy use cost event.

6. The energy management system of claim 1 wherein the audible source is a series of buzzes or beeps.

7. The energy management system of claim 1 wherein the audible signal may be emitted from more than one location of the energy management system.

8. The energy management system of claim 7 wherein an audible signal is capable of being emitted from any appliance with a microcontroller and speaker.

9. The energy management system of claim 1 wherein an audible signal is capable of being emitted from any appliance with a microcontroller and speaker.

10. A method of alerting a consumer of a peak pricing event comprising:
receiving information relating to cost of energy use;
communicating data to a home energy management system regarding the cost of energy; and
providing an audible alert in response to the cost of energy reaching a predetermined threshold.

11. The method of claim 10 further including integrating an audible source into the system that receives the information relating to the cost of energy use.

12. The method of claim 11 wherein the audible source is included in a home energy manager.

13. The method of claim 12 wherein the audible source is included in at least one home appliance.

14. The method of claim 10 wherein the audible source is included in at least one home appliance.

15. The method of claim 10 further comprising providing a disable function for selectively inactivating the audible alert.

16. The method of claim 10 wherein the audible alert is provided in advance of the peak pricing event.

17. The method of claim 10 further comprising using the audible alert in conjunction with other forms of alerts.

18. The method of claim 17 wherein the other form of alert includes a visual alert.

19. The method of claim 17 wherein the other form of alert is a text message.

20. The method of claim 10 wherein the audible source is included in at least one home appliance, and operation of the one home appliance is altered in response to the information received with respect to the cost of energy.
